(19) United States
(12) Patent Application Publication
(10) Pub. No.: US 2008/0030045 A1
(43) Pub. Date: Feb. 7, 2008

(54) Door system for a motor vehicle and method for operating a door system

(75) Inventors: Jackie Lai, Mountain View, CA (US); Brian Finn, East Palo Alto, CA (US); Philippe Alessandrini, Palo Alto, CA (US)

Correspondence Address: MANFRED BECK, P.A., 830 TYLER STREET, HOLLYWOOD, FL, 33019-1327, US

(73) Assignee: Volkswagen of America, Inc., Auburn Hills, MI (US)

(21) Appl. No.: 11/500,247

(22) Filed: Aug. 7, 2006

(51) Int. Cl. B60J 5/00

(52) U.S. Cl. 296/146.1

(57) ABSTRACT

A door system for a motor vehicle is provided. The door system includes a door for closing the interior space of a motor vehicle, a sensor for determining an opening angle of the door, a man-machine interface for inputting a desired maximum opening angle of the door, a brake device for arresting the door, and a door control for arresting the door through the use of the brake device if the opening angle of the door reaches the set maximum opening angle of the door or if an opening speed of the door falls below a limit value. A method for operating a door system is also provided.

### BACKGROUND OF THE INVENTION

### Field of the Invention

The invention relates to a door system for a motor vehicle including a brake device for arresting a door that closes the interior of the motor vehicle. The invention also relates to a method for operating a door system for a motor vehicle.

Such a door system, which is called a controllable motor vehicle door stop, is disclosed in German Patent Application Publication No. DE 40 25 510 A1. The door system disclosed in DE 40 25 510 A1 is formed of a door-holding member, which is articulated on a door arrangement part, a door or a door pillar, and of a braking or holding device interacting with the door-holding member and fastened fixedly to the other door arrangement part. An electromagnetic stopping device, which can be activated, is assigned as a holding device to a door-holding member which is formed as a rigid door-holding rod.

German Patent Application Publication No. DE 41 19 579 A1 discloses a device for detecting objects in a blind spot of a motor vehicle. The device for detecting objects includes a distance measuring device which is pointed in a contactless manner at the blind spot and includes a controlled door brake which can be activated prior to or during movement of the door when an object approaches the motor vehicle.

German Patent No. DE 195 37 619 C2 discloses a device for monitoring the traffic space of a motor vehicle. The device for monitoring has at least one traffic sensor for determining an object approaching the vehicle and has a corresponding signaling system and/or a blocking device for at least one door that operates when the vehicle has stopped or has nearly stopped, wherein the system or the blocking device is activated when a person/hand approaches at least a door handle and wherein the opening of at least one door of the vehicle is prevented, impeded or blocked when an object approaches the traffic space and/or an optical and/or acoustic signaling system indicates the approaching of the object. In this case at least one sensor detects the state of action of the vehicle.

German Patent Application Publication No. DE 195 37 816 A1 and European Patent Application Publication No. EP 0 705 951 A1 disclose a braking device for arresting a door, wherein the braking device is embodied as a continuously adjustable power-actuated door stop device and wherein the braking device includes an electromotive drive which is controllable by an electronic control unit for the purpose of braking or releasing the door in dependence on a current open position of the door, the direction of movement, and the current movement speed of the door as well as other data which are essential for evaluating the movement characteristics of the door such as the weight of the door, the angle of inclination of the vehicle, and the internal resistance of the door articulation. Further braking devices for arresting a door are disclosed in German Patent No. DE 100 07 317 C2, in International Publication No. WO 03/093620 A1, in International Publication No. WO 2004/001170 A1 and in International Publication No. WO 01/33018 A1.

German Patent Application Publication No. DE 195 33 804 A1 discloses a vehicle having at least one door which is pivotable about a substantially vertical axis. The door has a power-actuated stopping device for limiting the door opening angle. A sensor which operates contactless and which is disposed at the outer door edge that is remote from the axis is assigned to the stopping device. The sensor triggers the stopping device for arresting the door substantially without delay at a given distance from an object when approaching the object adjacent to the vehicle during an opening of the door.

German Patent Application Publication No. DE 197 54 167 A1 discloses a device for a continuously adjustable arresting of a door, the device having at least a cylinder and a piston, an electro-rheological or magneto-rheological liquid, a control electronic, through the use of which a changeable electric or magnetic field strength in the rheological liquid is adjustable, and having a device for detecting or inputting a desired arresting position, wherein the control electronic is controllable in dependence on the detected or input arresting position.

German Patent Application Publication No. DE 198 36 310 A1 discloses a restraint device for a vehicle door that mechanically restrains the opening at the latest at a still safe opening angle and/or triggers an acoustic and/or optical restraint signal. The restraint device is controlled through the use of a monitoring device which monitors the vehicle's exterior region for the presence of stationary and/or approaching obstacles, especially in the opening range of the respective vehicle door.

German Patent Application Publication No. DE 198 08 181 A1 discloses a device for collision protection of projecting parts of motor vehicles that has a controllable actuating mechanism at least for retracting or folding the projecting vehicle parts. At least one distance detection sensor or proximity sensor, which is functionally connected to the actuating mechanism, is provided on the vehicle, for example disposed in an outside rear view mirror, in order to detect the distance and/or the approach of an object relative to a respective projecting vehicle part. The actuating device retracts or folds the respective vehicle part in response to a detection signal supplied by the sensor and indicating a danger of collision with the object.

German Patent Application Publication No. DE 100 56 569 A1 discloses a vehicle having at least a pivotable door and a device for preventing a collision of the door with an object adjacent to the vehicle during opening of the door. A sensor having an evaluation logic detects the object with respect to its position and its change of position relative to the vehicle during a vehicle motion directly preceding the opening of the door. In case of a risk of collision between the object and the vehicle, a warning signal or a stopping device is triggered.

German Patent Application Publication No. DE 100 04 161 A1 and European Patent Publication No. EP 1 265 772 B1 disclose an adaptive door safeguarding system for motor vehicles including a safeguarding device, which allows or prevents the opening of a door of a motor vehicle according to at least one sensor-detected situation of the environment of the vehicle, further including a door locking system and a vehicle environment sensor system provided on or in the motor vehicle, and including a monitoring device acting upon the door locking system. The vehicle environment sensor system produces signals which are supplied to the monitoring device controlling the door locking system in such a way that the door is kept in a locked position by the locking system either on a continuous basis or for a specific or set length of time if the signals provided by the vehicle environment sensor system indicate that the safety during opening of the door is jeopardized by a situation in the environment of the vehicle.

U.S. Patent Application Publication No. 2005/0280518 A1 and corresponding German Patent Application Publication No. DE 10 2004 040 399 A1 disclose a door system for a motor vehicle including a door, an environment sensor for detecting an obstacle in the vicinity of the vehicle, a door sensor for outputting an output signal as a function of the initiation of the opening of the door and a control unit for detecting an imminent collision between the door and the obstacle as a function of an output signal of the environment sensor and for activating a warning device such that a warning may be output by the warning device in response to the detection of an imminent collision between the door and the obstacle. When activating the warning device, the control unit distinguishes between at least two selectable warning stages, a first warning stage and a second warning stage, wherein the selection of a warning stage by the control unit is a function of the output signal of the door sensor.

### SUMMARY OF THE INVENTION

It is accordingly an object of the invention to provide an improved door system which overcomes disadvantages of the heretofore-known door systems of this general type.

With the foregoing and other objects in view there is provided, in accordance with the invention, a door system for a motor vehicle, including:

a door configured to close a motor vehicle interior;
a sensor configured to determine an opening angle of the door;
a man-machine interface configured to accept an input for setting a desired maximum opening angle for the door;
a brake device configured to arrest the door; and
a door control operatively connected to the sensor and to the man-machine interface, the door control being configured to arrest the door with the brake device if the opening angle of the door reaches the maximum opening angle set for the door or if an opening speed of the door falls below a given limit value.

In other words, according to the invention, there is provided a door system for a motor vehicle with a door for closing the interior space of a motor vehicle, with a sensor for determining an opening angle of the door, with a man-machine interface for inputting a desired maximum opening angle of the door, with a brake device for arresting the door, and with a door control for arresting the door through the use of the brake device, if (either) the opening angle of the door reaches the set maximum opening angle of the door or if an opening speed of the door falls below a limit value, in particular for at least a tolerance time. A door in accordance with the invention may in particular be a side door or a tailgate of a motor vehicle. Suitable brake devices are for example available from LORD CORPORATION (www.lord.com).

In accordance with another feature of the invention, the man-machine interface is configured to accept an input for selectively activating and deactivating the function for arresting the door with the brake device if the opening speed of the door falls below the given limit value. The function for arresting the door through the use of the brake device if an opening speed of the door falls below a limit value, may also be activated and/or deactivated by a man-machine interface other than the man-machine interface mentioned above.

According to another feature of the invention, the door control arrests the door if the opening speed of the door falls below a given limit value for a given tolerance period.

According to yet another feature of the invention, the door has a side facing away from the motor vehicle interior; and an operating element for releasing an arresting of the door is disposed on the side of the door facing away from the motor vehicle interior.

According to another feature of the invention, the door has a side facing the motor vehicle interior; and an operating element for releasing an arresting of the door is disposed on the side of the door facing the motor vehicle interior.

According to another feature of the invention, the door system includes an environment sensor operatively connected to the door control and configured to detect an obstacle in a vicinity of the motor vehicle.

According to a further feature of the invention, the environment sensor provides an output signal to the door control; and the door control is configured to detect an imminent collision between the door and the obstacle in dependence on the output signal from the environment sensor. In accordance with the invention, the environment sensor may in particular be a ultrasound sensor, a radar sensor or a laser sensor. Suitable environment sensors may be gathered from U.S. Patent Application Publication No. 2005/0280518 A1 which is hereby incorporated by reference. If an obstacle is detected, then the output of a warning and/or an arresting of the door through the use of the brake device can be provided.

With the objects of the invention in view there is also provided, a door system for a motor vehicle, including:

a door configured to close a motor vehicle interior;
a sensor configured to determine an opening angle of the door;
a brake device configured to arrest the door;
a door control operatively connected to the sensor, the door control being configured to arrest the door with the brake device if an opening speed of the door falls below a given limit value; and
an operating element configured to release an arresting of the door.

In other words, according to the invention, there is provided a door system for a motor vehicle that includes in particular one or more of the above-mentioned features wherein the door system includes a door for closing the interior of a motor vehicle, a sensor for determining an opening angle of the door, a brake device for arresting the door, a door control for arresting the door through the use of the brake device if an opening speed of the door falls below a limit value, and an operating element, in particular an operating element that is different from the man-machine interface, for releasing the arresting of the door. Such an operating element can be provided on a side of the door facing the interior of the motor vehicle and/or on a side of the door facing away from the interior of the vehicle.

According to the invention, there is also provided, a door system for a motor vehicle, including:

a door configured to close a motor vehicle interior;
a sensor configured to determine an opening angle of the door;
a man-machine interface configured to accept an input for setting a desired maximum opening angle for the door;
a brake device configured to arrest the door;
a door control operatively connected to the sensor and to the man-machine interface, the door control being configured to arrest the door with the brake device if an opening angle of the door reaches the maximum opening angle set for the door; and
an operating element configured to release an arresting of the door.

In other words, according to the invention, there is provided a door system for a motor vehicle that includes in particular one or more of the above-mentioned features wherein the door system includes a door for closing the interior of a motor vehicle, a sensor for determining an opening angle of the door, a man-machine interface for inputting a desired maximum opening angle of the door, a brake device for arresting the door, a door control for arresting the door through the use of the brake device if the opening angle of the door reaches the set maximum opening angle of the door, and an operating element for releasing an arresting of the door, in particular an operating element that is different from the man-machine interface. Such an operating element can be provided on a side of the door facing the interior of the motor vehicle and/or on a side of the door facing away from the interior of the vehicle.

In accordance with the invention, there is also provided a method for operating a door system that includes the steps of:

providing a door for closing an interior space of a motor vehicle;
inputting a desired maximum opening angle for the door;
determining an opening angle of the door; and
arresting the door if the opening angle of the door reaches the maximum opening angle set for the door or an opening speed of the door falls below a given limit value.

Another mode of the method according to the invention includes arresting the door if the opening speed of the door falls below a given limit value for a given tolerance period.

A further mode of the method according to the invention includes releasing an arresting of the door by actuating an operating element.

In other words, according to the invention, there is provided a method for operating a door system for a motor vehicle that includes in particular one or more of the above-mentioned features wherein a desired maximum opening angle of the door is input, wherein an opening angle of the door is determined, and wherein the door is arrested if (either) the opening angle of the door reaches the set maximum opening angle of the door or an opening speed of the door falls below a limit value, in particular if the opening speed of the door falls below a limit value for at least a tolerance period. In accordance with a further mode of the invention, the arrested state of the door is released by actuating an operating element. The operating element can be provided on a side of the door facing the interior of the motor vehicle and/or on a side of the door facing away from the interior of the motor vehicle.

In accordance with the invention, a sensor for determining an opening angle of the door can also be a sensor for determining an opening speed of the door.

A motor vehicle for the purpose of the invention is in particular a land vehicle which can be used as a personal vehicle in road traffic. Motor vehicles for the purpose of the invention are in particular not limited to land vehicles having a combustion engine.

Although the invention is illustrated and described herein as embodied in a door system for motor vehicles, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1. is a schematic view of an exemplary embodiment of a door system for a motor vehicle in accordance with the invention; and

FIG. 2 is a state transition diagram of an exemplary mode of a method according to the invention for operating the door system shown in FIG. 1.

### DESCRIPTION OF THE PREFERRED EMBODIMENTS

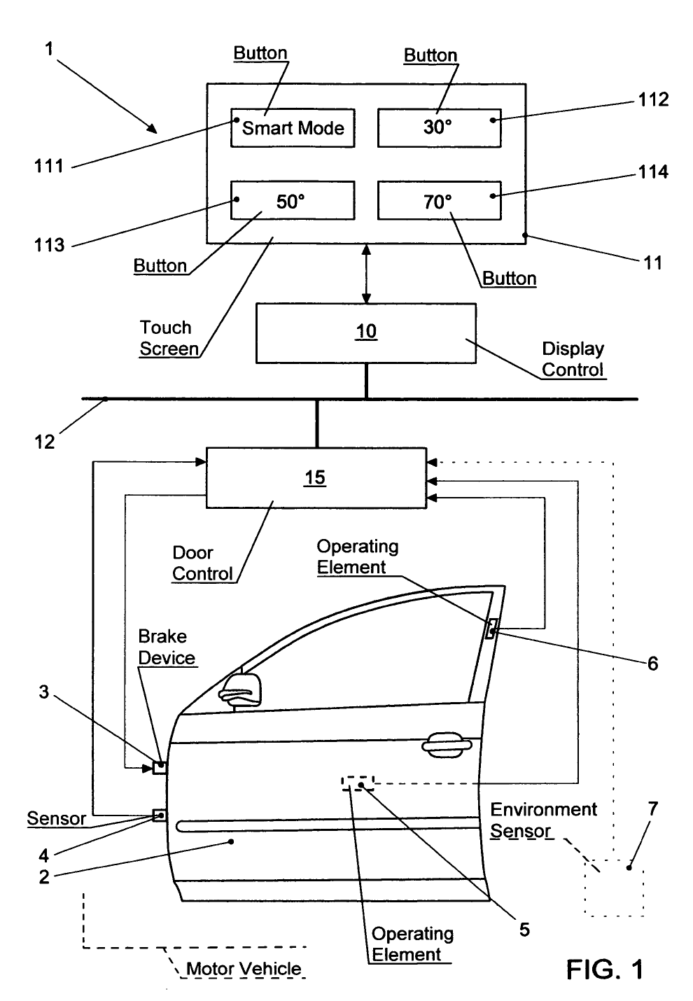

Referring now to the figures of the drawings in detail and first, particularly, to FIG. 1 thereof, there is shown an exemplary embodiment of a door system 1 for a motor vehicle wherein the motor vehicle is only schematically indicated by a dashed line. The door system 1 includes a door 2 for closing the interior of the motor vehicle, a brake device 3 for arresting the door 2, i.e. blocking a movement of the door 2, and a sensor 4 for determining an opening angle of the door 2. Suitable brake devices 3 are for example available from LORD CORPORATION (www.lord.com). In FIG. 1, the brake device 3 and the sensor 4 are shown as separate devices, however, they may also be integrated in one device.

The door system 1 includes a man-machine interface for inputting settings of the door system, wherein the man-machine interface is embodied as a touch screen 11 and a display control 10 is assigned to the man-machine interface. For example, desired maximum opening angles for the door 2 can be selected in this manner. In the present exemplary embodiment buttons 112, 113, and 114 are displayed by the touch screen 11 for this purpose. An operator can set the desired maximum opening angle to 30°, 50° or 70° by using these buttons 112, 113, and 114. In addition, a button 111 is provided for activating and deactivating a function that is denoted in the following as smart mode.

The door system 1 further includes a door control 15 for arresting the door 2 by the brake device 3 if the opening angle of the door 2 reaches the set maximum opening angle or, in case the smart mode function is activated, an opening speed of the door 2 falls below a limit value, in particular for at least a tolerance time. The door control 15 is connected to the display control 10 via a bus system 12 for data transfer. The door system 1 includes furthermore respectively at least an operating element 6 and, respectively, 5 disposed on a side of the door facing away from the interior of the motor vehicle or on a side of the door facing the interior of the motor vehicle for releasing the arresting of the door 2.

The door system 1 may also be provided such that the door system 1 includes an environment sensor 7 for detecting an obstacle in a vicinity of the motor vehicle, wherein the environment sensor 7 is for example embodied as an ultrasound sensor, a radar sensor or a laser sensor. Suitable environment sensors are for example disclosed in U.S. Patent Application Publication No. 2005/0280518 A1 which is hereby incorporated by reference. It is advantageous if the environment sensor 7 is used or can be used also by a driver assistance system. When an environment sensor 7 is provided, it is possible to detect with the door control 15 an imminent collision of the door 2 and the obstacle in dependence on an output signal of the environment sensor 7. When an obstacle is detected, a warning may be output and/or the door 2 may be arrested by the brake device 3.

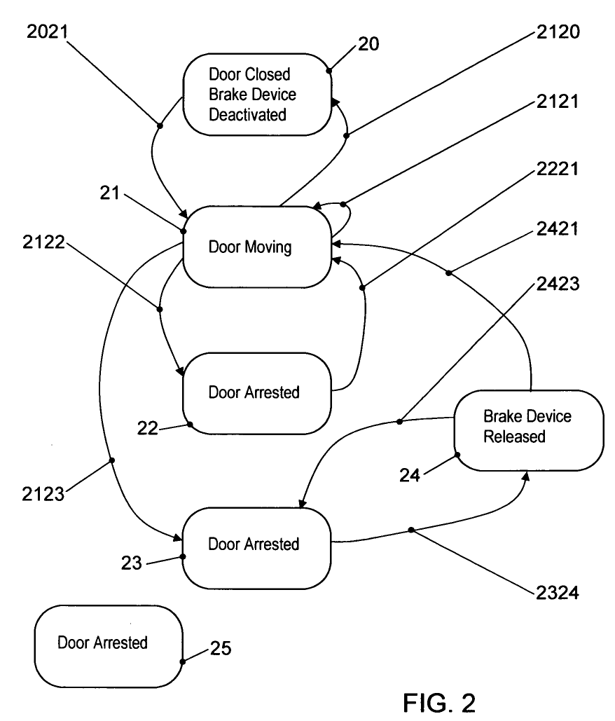

FIG. 2 shows an exemplary mode of a method for operating the door system 1 represented as a state transition diagram. Reference numerals 20, 21, 22, 23, and 24 denote states and reference numerals 2021, 2120, 2121, 2122, 2123, 2221, 2324, 2421 and 2423 denote state transitions. In state 20, the door 2 is closed and the brake device is deactivated. By moving (state transition 2021) the door 2 (in particular beyond an opening limit value), the door system 1 makes a transition to state 21 in which the door 2 is moved. In this state, the door control 15 monitors the output signal of the sensor 4 for determining an opening angle of the door 2 and determines from this output signal the opening speed of the door 2 (state transition 2121).

If the so-called smart mode is activated, the door system makes a transition to the state 22, if the opening speed of the door 2 goes beyond a limit value for more than 150 milliseconds (state transition 2122). In state 22, the door 2 is arrested. In this state, the door control 15 monitors whether the operating element 5 or the operating element 6 is actuated. If the operating element 5 or the operating element 6 is actuated (state transition 2221), the door system 1 makes a transition back to state 21.

If the opening angle of the door 2 reaches the set maximum opening angle of the door 2 (state transition 2123), the door system 1 makes a transition from state 21 to state 23. In the state 23 the door 2 is also arrested. In this state, the door control 15 monitors whether the operating element 5 or the operating element 6 is actuated and whether the door 2 is moved in a direction towards closing the door 2. If either the operating element 5 and, respectively, the operating element 6 is actuated or the door 2 is moved in the direction of closing the door 2 (state transition 2324), then the door system 1 makes a transition from state 23 to state 24. In the state 24, the brake device is released and the door control 15 monitors the output signal of the sensor 4 for determining an opening angle of the door 2. When the opening angle of the door 2 reaches the set maximum opening angle of the door 2 (state transition 2423), the door system 1 transitions from state 24 back to state 23.

When the opening angle of the door 2 falls below a safety limit value (state transition 2421), the door control 15 regards the door 2 as being moved, i.e. the door system 1 transitions from state 24 to state 21.

If an environment sensor 7 is provided, then an additional state 25 is provided in which the door 2 is arrested. State transitions into state 25 may for example be provided from states 21 and 24.

### LIST OF REFERENCE NUMERALS

1 door system
2 door
3 brake device
4 sensor for determining an opening angle of a door
5,6 operating element
7 environment sensor
10 display control
11 touch screen
12 bus system
15 door control
20, 21, 22,
23, 24, 25 state
111, 112, 113, 114 button
2021, 2120, 2121,
2122, 2123, 2221,
2324, 2421, 2423 state transition

We claim:

1. A door system for a motor vehicle, comprising:
a door configured to close a motor vehicle interior;
a sensor configured to determine an opening angle of said door;
a man-machine interface configured to accept an input for setting a desired maximum opening angle for said door;
a brake device configured to arrest said door; and
a door control operatively connected to said sensor and to said man-machine interface, said door control being configured to arrest said door with said brake device if one of the opening angle of said door reaches the maximum opening angle set for said door and an opening speed of said door falls below a given limit value.

2. The door system according to claim 1, wherein said man-machine interface is configured to accept an input for selectively activating and deactivating a function for arresting said door with said brake device if the opening speed of said door falls below the given limit value.

3. The door system according to claim 1, wherein said door control arrests said door if the opening speed of said door falls below a given limit value for a given tolerance period.

4. The door system according to claim 1, wherein:
said door has a side facing away from the motor vehicle interior; and
an operating element for releasing an arresting of said door is disposed on said side of said door facing away from the motor vehicle interior.

5. The door system according to claim 1, wherein:
said door has a side facing the motor vehicle interior; and
an operating element for releasing an arresting of said door is disposed on said side of said door facing the motor vehicle interior.

6. The door system according to claim 1, including an environment sensor operatively connected to said door control, said environment sensor being configured to detect an obstacle in a vicinity of the motor vehicle.

7. The door system according to claim 6, wherein:
said environment sensor provides an output signal to said door control; and
said door control is configured to detect an imminent collision between said door and the obstacle in dependence on the output signal from said environment sensor.

8. A door system for a motor vehicle, comprising:
a door configured to close a motor vehicle interior;
a sensor configured to determine an opening angle of said door;
a brake device configured to arrest said door;
a door control operatively connected to said sensor, said door control being configured to arrest said door with said brake device if an opening speed of said door falls below a given limit value; and
an operating element configured to release an arresting of said door.

9. The door system according to claim 8, wherein:
said door has a side facing the motor vehicle interior; and
said operating element is disposed on said side of said door facing the motor vehicle interior.

10. The door system according to claim 8, wherein:
said door has a side facing away from the motor vehicle interior; and
said operating element is disposed on said side of said door facing away from the motor vehicle interior.

11. A door system for a motor vehicle, comprising:
a door configured to close a motor vehicle interior;
a sensor configured to determine an opening angle of said door;
a man-machine interface configured to accept an input for setting a desired maximum opening angle for said door;
a brake device configured to arrest said door;
a door control operatively connected to said sensor and to said man-machine interface, said door control being configured to arrest said door with said brake device if an opening angle of said door reaches the maximum opening angle set for said door; and
an operating element configured to release an arresting of said door.

12. The door system according to claim 11, wherein:
said door has a side facing the motor vehicle interior; and
said operating element is disposed on said side of said door facing the motor vehicle interior.

13. The door system according to claim 11, wherein:
said door has a side facing away from the motor vehicle interior; and
said operating element is disposed on said side of said door facing away from the motor vehicle interior.

14. A method for operating a door system, the method which comprises:
providing a door for closing an interior space of a motor vehicle;
inputting a desired maximum opening angle for the door;
determining an opening angle of the door; and
arresting the door if one of the opening angle of the door reaches the maximum opening angle set for the door and an opening speed of the door falls below a given limit value.

15. The method according to claim 14, which comprises arresting the door if the opening speed of the door falls below a given limit value for a given tolerance period.

16. The method according to claim 14, which comprises releasing an arresting of the door by actuating an operating element.
